(19) United States
(12) Patent Application Publication
(10) Pub. No.: US 2021/0129072 A1
(43) Pub. Date: May 6, 2021

(54) Concept and expression method of energy efficiency index (EEI) COPCO2 for carbon-capture system

(71) Applicant: Tianjin University, Tianjin (CN)

(72) Inventors: Shuai DENG, Tianjin (CN); Yaofeng XU, Tianjin (CN); Jianxin FU, Tianjin (CN); Li ZHAO, Tianjin (CN); Yangzhou ZHOU, Tianjin (CN); Shuangjun LI, Tianjin (CN); Jun ZHAO, Tianjin (CN)

(21) Appl. No.: 17/075,564

(22) Filed: Oct. 20, 2020

(30) Foreign Application Priority Data
Oct. 21, 2019 (CN) 201910998077.5

(51) Int. Cl. B01D 53/14; G06F 17/11

(52) U.S. Cl. CPC B01D 53/14; B01D 2257/504; G06F 17/11

(57) ABSTRACT

The present disclosure discloses the concept and expression method of an energy efficiency index (EEI) COP_{CO}_{₂} for a carbon-capture system. The COP_{CO}_{₂} refers to the ratio of the gain during a carbon-capture process to the cost practically, and to the ratio of the increase of CO₂ chemical potential resulting from enrichment to the driving work input into the carbon-capture system physically. By introducing the concept of environmental effective state (G state), the present disclosure quantifies the “gain” during a carbon-capture process, and compares the “gain” with the “cost” to obtain the COP_{CO}_{₂} expression method of coefficient of performance (COP) during the carbon-capture process, which provides more accurate evaluation for the energy utilization level during a carbon-capture process and is conducive to improving the energy utilization level by carbon-capture technology, thereby improving the energy utilization rate.

### CROSS-REFERENCE TO RELATED APPLICATIONS

This application claims priority to Chinese Patent Application No. 201910998077.5 filed on Oct. 21, 2019, the entire contents of which is hereby incorporated by reference.

### TECHNICAL FIELD

The present disclosure relates to the thermodynamic research field of carbon-capture technology, particularly to the evaluation parameter field of carbon capture energy efficiency, and more particularly to the concept and expression method of an energy efficiency index (EEI) COP_{CO}_{₂} for a carbon-capture system.

### BACKGROUND

With the progress of human activities, the average concentration of CO₂ in the atmosphere has exceeded 400 ppm. The global greenhouse effect is aggravated due to CO₂ emissions, which leads to many environmental problems, such as sea level rise, glacial ablation, accelerated species extinction, and other severe environmental survival challenges.

In this context, the carbon-capture technology, as a technology that can effectively reduce CO₂ emissions, has attracted a lot of attention. On Dec. 12, 2015, the international cooperation to jointly fight against global warming was decided by the Paris Agreement, and it was expected to limit the rise in global average temperature in this century to below 2° C. To control the temperature rise to below 2° C., both the Intergovernmental Panel on Climate Change (IPCC) and the International Energy Agency (IEA) have highlighted the important role of carbon capture and storage (CCS) in achieving long-term, efficient reduction of carbon dioxide emissions. CCS is considered to be one of the effective means to cope with the challenge of climate change, and exhibits the following irreplaceable advantages in reduction of carbon dioxide emissions: (1) With stable operation and strong adaptability to existing thermal power plants with large CO₂ emissions, CCS can realize substantial reduction in carbon dioxide emissions of a power system and is an important means for ensuring energy security and achieving sustainable development. (2) CCS is of great significance for achieving large-scale emission reduction in coal-intensive industries such as coal chemicals, steel, cement and oil refineries, and CCS can work together with renewable energy to achieve the decarbonization goal in a complementary manner. (3) Carbon dioxide direct air capture (DAC) and bioenergy CCS (BECCS) can achieve large-scale negative emissions.

However, as an energy-intensive technology, carbon-capture technology has large energy consumption per unit capture volume, which limits the scale expansion thereof.

The development of carbon-capture technology is limited by its high energy consumption per unit capture volume. In recent years, inventions in the field of energy efficiency research and energy efficiency evaluation on a carbon-capture system mainly have the following characteristics:

For example, Chinese patent CN109173558A relates to a low-energy CCS system with low energy consumption, where, after combustion, the carbon-capture system of a power plant combines the recovery of flue-gas compression and expansion work with the recovery of waste heat of a heat regenerator, so as to reduce power consumption and increase efficiency to the maximum extent. Chinese patent CN104107629B provides a flue-gas carbon dioxide capture system and method, where, the system includes a carbon dioxide absorption tower, an ammonia-detection and ammonia-recovery integrated structure, an absorbent preparation device, a heat-exchange and regeneration structure, and a multistage compression and segmented heat-removal structure, which can recycle waste heat, reduce energy consumption in absorbent regeneration, and avoid ammonia volatilization loss in ammonia carbon capture, resulting in reduced operating costs. Chinese patent CN103752142B discloses an integrated system for solar-assisted carbon dioxide capture, which reasonably allocates and integrates the energy demand grades of related components between the solar heat-collection and power-generation subsystem and the carbon dioxide capture subsystem to achieve the cascade utilization of energy and reduce the extraction steam of a power plant and the energy consumption of carbon capture. In summary, it can be seen that the existing related patents cannot achieve the above-mentioned goal of developing an ideal thermodynamic research method. Specifically, an efficiency analysis model for carbon capture needs to be embodied at the cyclical level for in-depth analysis, and researchers engaged in carbon capture by absorption have realized the importance of thermodynamic research. The convergence of these two aspects forces us to give profound consideration to the following question: how to start the construction of a thermodynamic carbon pump cycle in, for example, carbon capture by adsorption. For example, Chinese patent CN108304996A relates to an investment analysis method for coordinating a low-carbon-benefit-based carbon-capture system with wind power, which introduces the value engineering theory to establish a mathematical description for low-carbon benefit and make it comparable in different technologies or evaluation methods, and provides an investment plan for economic development trends and emission reduction requirements involving technical feasibility, economic rationality, and social friendliness. The method is proposed to provide a scientific basis for overall energy planning, improve the overall social investment efficiency, and indirectly reduce the emission of environmental pollutants. For example, Chinese patent CN108416113A discloses a collaborative optimization method for the entire carbon capture, utilization and storage (CCUS) process based on carbon dioxide enrichment rate, which comprehensively considers the comprehensive indicators of the entire CCUS process to realize the collaborative optimization design for a system. The method is proposed to achieve the overall optimal design for the entire CCUS process.

In addition, the concept of coefficient of performance (COP) is currently used merely for traditional refrigerant heat pumps in existing patents, and it is not discovered that the concept of COP has been applied to the energy efficiency evaluation of carbon-capture technology on line.

To sum up, existing patents do not involve energy efficiency evaluation indexes of carbon-capture technology, and also do not expand the traditional concept of COP, that is, the ratio of gain to cost is not extended to a physical meaning, such as the ratio of the increase of CO₂ chemical potential resulting from enrichment to the driving work input into a carbon-capture system, which can be applied to the energy efficiency evaluation of carbon-capture technology.

Therefore, based on the traditional thermodynamic evaluation index COP, and in combination with the significance of the ratio of gain to cost for carbon-capture technology, COP_{CO}_{₂} is proposed, which is an innovative and reasonable evaluation index.

### SUMMARY

The present disclosure is intended to evaluate the energy consumption level of the existing carbon-capture technology, which plays a role similar to “energy consumption ceiling” to guide the carbon-capture technology.

The environmental effective energy G state is calibrated according to the atmospheric composition, pressure, and temperature in the environment. The establishment of COP_{CO}_{₂} is based on the effective energy G state of CO₂ in the environment. The G state is specified as: 298.15 K, environmental pressure P=0.101325 MPa, and CO₂ concentration in the environment: 0.04%. As long as the CO₂ concentration is higher than the G state, it is a useful energy state.

COP_{CO}_{₂} refers to the ratio of the gain of a carbon-capture system to the cost practically, and to the ratio of the increase of CO₂ chemical potential resulting from enrichment to the driving work input into the carbon-capture system physically. The illustration is shown in FIG. 1, and the calculation formula is shown in formula 1.

$${COP}_{{CO}_{2}} = \frac{Gain}{Cost} = \frac{Δ G}{Δ W} = \frac{( Δ {G}_{1} + Δ {h}_{1} ) + ( {W}_{min} + Δ {h}_{2} )}{{W}_{min} + Δ {h}_{2}} \qquad ( 1 )$$

The numerator represents the gain during a carbon-capture process, namely, the increase of CO₂ chemical potential resulting from enrichment, which is characterized by increase in the concentration and temperature of CO₂, where, the increase in CO₂ concentration is numerically equal to the sum of the difference between the effective energy of the original gas and the effective energy of CO₂ at G state (namely, ΔG₁) with the minimum separation work required during a carbon-capture process (namely, Wₘᵢₙ); and the increase in CO₂ temperature is numerically equal to the sum of the absolute value of the enthalpy difference obtained when the gas changes from the state P₀ at T₀ to the state P₁ at T₁ (namely, Δh₁) with the absolute value of the enthalpy difference obtained when the gas changes from the state P₁ at T₁ to the state P₂ at T₂ (namely, Δh₂).

The denominator represents the cost, namely, the minimum driving work required during a carbon-capture process to drive CO₂ enrichment, which has a value equal to the sum of the minimum separation work Wₘᵢₙ and the enthalpy change resulting from the gas after the enrichment is upgraded.

In terms of expression, COP_{CO}_{₂} is similar to the meaning of COP in refrigerant heat pumps where a driving work is used to pry the original part of heat to improve the heat grade. COP_{CO}_{₂} refers to the Gibbs free energy change caused when a driving work is used to increase the chemical potential of the original gas.

### BRIEF DESCRIPTION OF DRAWINGS

FIG. 1 is a schematic diagram illustrating the derivation of COP_{CO}_{₂} according to the present disclosure.

FIG. 2 is a framework diagram for the thermodynamic principle according to the present disclosure.

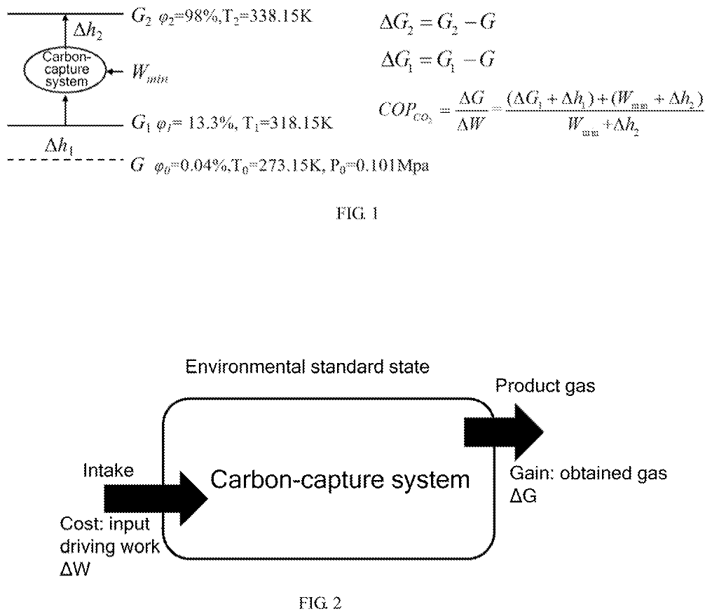

### DETAILED DESCRIPTION

The solutions of the present disclosure are further described in detail below with reference to the accompanying drawings and specific embodiments. The specific embodiments described are only used to explain the present disclosure, but not to limit the present disclosure.

Under the framework of classic thermodynamics, the present disclosure expands the thermodynamic evaluation parameter COP to allow it to be applied to a novel energy-mass conversion system of carbon-capture technology.

The COP_{CO}_{₂} refers to the ratio of the gain of a carbon-capture system to the cost practically, and specifically to the ratio of the increase of CO₂ chemical potential resulting from enrichment to the driving work input into the carbon-capture system physically. As shown in the formula (1), the numerator represents the Gibbs free energy change during a carbon-capture process, which is calculated from captured gas, product gas obtained from capture, and exhaust gas. The cost refers to the driving work input into a carbon-capture system, which is used to pry the increase of the gas chemical potential, thereby bringing Gibbs free energy change, as shown in FIG. 2.

The derivation and calculation method of COP_{CO}_{₂} is exemplified below. For example, under the following conditions: flue-gas Φ_{1,X} (X represents gas types such as CO₂ and N₂) of a coal-fired power plant: 4 kmol CO₂/s, 5 kmol H₂O/s, 1 kmol O₂/s, and 20 kmol N/s; T₁: 45° C.; flue-gas pressure equal to standard state pressure: P₁=P₀; capture rate: 90%; product gas purity: 98%; T₂: 65° C.; and unchanged pressure, the following calculation results are obtained according to the derivation formula:

$$\begin{matrix}Δ {G}_{1} = RT ln ( \frac{13.3}{0.04} ) = 8.314 * 298.15 * ln ( \frac{13.3}{0.04} ) = 14394 J \text{/} mol = 327.14 kJ \text{/} kg & ( 2 ) \\ {W}_{min} = RT [ {n}_{B}^{{CO}_{2}} ln ( {y}_{b}^{{CO}_{2}} ) + {n}_{B}^{B - {CO}_{2}} ln ( {y}_{B}^{B - {CO}_{2}} ) + {n}_{C}^{{CO}_{2}} ln ( {y}_{C}^{{CO}_{2}} ) + {n}_{C}^{C - {CO}_{2}} ln ( {y}_{C}^{C - {CO}_{2}} ) - {n}_{A}^{{CO}_{2}} ln ( {y}_{A}^{{CO}_{2}} ) - {n}_{A}^{A - {CO}_{2}} ln ( {y}_{A}^{A - {CO}_{2}} ) ] = 6.88 kJ \text{/} mol = 156.36 kJ \text{/} kg & ( 3 )\end{matrix}$$

The calculation formulas of ΔG and Wₘᵢₙ are mentioned in general textbooks and are not the focus of the present disclosure.

The physical property state parameters of related gases can be directly obtained from commercial physical property databases such as NEST, i.e., Δh₁=20.35 kJ/kg and Δh₂=13.2 kJ/kg.

By exemplifying the standardized test of COP_{CO}_{₂} and applying corresponding values to the formula for calculation, it can be seen that this carbon-capture system has the COP_{CO}_{₂}=3.05.

Though the present disclosure is described above in conjunction with figures, the present disclosure is not limited to the above specific implementations, which are merely exemplary rather than restrictive. Other similar evaluation indexes for a carbon-capture system proposed by those of ordinary skill in the art in accordance with the teachings of the present disclosure shall fall within the protection scope of the present disclosure.

1. Concept and expression method of an energy efficiency index (EEI) COP_{CO}_{₂} for a carbon-capture system, wherein, the EEI refers to the ratio of the gain of the carbon-capture system to the cost practically, and to the ratio of the increase of CO₂ chemical potential resulting from enrichment to the driving work input into the carbon-capture system physically, indicating the energy conversion efficiency of the carbon-capture system.

2. The concept and expression method of an EEI COP_{CO}_{₂} for a carbon-capture system according to claim 1, wherein, the COP_{CO}_{₂} for a carbon-capture system has the following mathematical expression:
$${COP}_{{CO}_{2}} = \frac{Gain}{Cost} = \frac{Δ G}{Δ W} = \frac{( Δ {G}_{1} + Δ {h}_{1} ) + ( {W}_{min} + Δ {h}_{2} )}{{W}_{min} + Δ {h}_{2}} .$$
